(19) United States
(12) Patent Application Publication
(10) Pub. No.: US 2014/0212764 A1
(43) Pub. Date: Jul. 31, 2014

(54) STORAGE BATTERY GRID, METHOD OF MANUFACTURING STORAGE BATTERY GRID, AND STORAGE BATTERY USING STORAGE BATTERY GRID

(71) Applicants: Kohei Fujita, Kyoto (JP); Kiyoshi Nouzuka, Kyoto (JP); Shota Iwasaki, Kyoto (JP); Junichi Nishizawa, Kyoto (JP); Kazuma Saito, Kyoto (JP); Hiroyuki Ishiguro, Kyoto (JP)

(72) Inventors: Kohei Fujita, Kyoto (JP); Kiyoshi Nouzuka, Kyoto (JP); Shota Iwasaki, Kyoto (JP); Junichi Nishizawa, Kyoto (JP); Kazuma Saito, Kyoto (JP); Hiroyuki Ishiguro, Kyoto (JP)

(73) Assignee: GS Yuasa International Ltd., Kyoto (JP)

(21) Appl. No.: 14/350,386

(22) PCT Filed: Jul. 23, 2013
(86) PCT No.: PCT/JP2013/004464

§ 371 Date: Apr. 8, 2014

(30) Foreign Application Priority Data
Sep. 10, 2012 (JP) 2012-198408

(51) Int. Cl. H01M 4/74

(52) U.S. Cl. CPC H01M 4/742
USPC 429/241; 29/2

(57) ABSTRACT

[Object] To regularize a potential distribution at a grid, prevent local corrosion, and lengthen product lifetime.

[Solution Means] A storage battery grid includes: a frame bone 2 that includes a substantially rectangular shape; a lug portion 21 that is formed upward from an upper side 2a of the frame bone 2; one or more main vertical bone 3X that extend downward from the lug portion 21 in the frame bone 2; plural slanted bones 4 that extend obliquely from the upper side 2a toward a lower side 2b, at least the slanted bones branching from the main vertical bone 3X, which is a center, toward both sides. The slanted bones 4 are arranged at intervals in a direction in which the main vertical bone 3X extends, and at least part of plural spaces, which are defined by the main vertical bone 3X partially forming a side of the spaces, include a substantially quadrilateral shape.

### TECHNICAL FIELD

The present invention relates to a storage battery grid, a method of manufacturing a storage battery grid, and a storage battery using a storage battery grid.

### BACKGROUND ART

An expanded grid (i.e., a net-like grid) obtained by forming slits in, for example, a zigzag manner on a lead alloy sheet, followed by expanding, has been conventionally used as a grid for use in a storage battery, as disclosed in Patent Document 1. The expanded grid includes an upper frame having a lug portion formed thereat, a lower frame opposed to the upper frame, and a net-like frame formed between the upper frame and the lower frame. A space defined by the upper frame, the lower frame, and the net-like frame is filled with an active material, thereby constituting an electrode plate.

However, the expanded grid has no frame bone for connecting the upper frame and the lower frame to each other on right and left sides, and therefore, is liable to be elongated in a height direction, and further, is likely to be curved and deformed in a planar direction, thereby raising a problem that the active material tends to fall down. The net-like frame of the expanded grid is serrate from the lower frame to the upper frame, and therefore, a current channel up to the lug portion becomes long, thereby increasing an electric resistance. Consequently, a potential distribution becomes uneven over the entire electrode plate, thereby raising problems of local corrosion and a short lifetime of the electrode plate.

In the meantime, a cast grid including, inside of a square frame bone, many lateral frames parallel to each other and many radial frames radially extending from a lug portion disposed on an upper side of the frame bone is conceived as a grid for use in a storage battery, as disclosed in Patent Document 2. The radial frames are formed with branch frames. Each of the branch frames includes: a branch starting frame extending sideways at a large angle with respect to the base of the radial frame; and a bent starting frame continuous to the branch starting frame and bent in a radial direction.

However, the cast grid includes a portion that does not extend toward the lug portion (in particular, the branch starting frame) on a channel from the lower section toward the upper section along the branch frame, and therefore, a current channel up to the lug portion becomes long, resulting in an increase in electric resistance. Consequently, a potential distribution becomes uneven over the entire electrode plate, thereby raising problems of local corrosion and a short lifetime of the electrode plate.

### PRIOR ART DOCUMENTS

### Patent Documents

Patent Document 1: JP-A-7-320743
Patent Document 2: JP-Y-8-2921

### SUMMARY OF THE INVENTION

### Problems to be Solved by the Invention

In view of the above, a main object of the present invention is to enhance the mechanical strength of a grid, and further, reduce the electric resistance of the grid to regularize a potential distribution of the grid.

### Means for Solving the Problems

A storage battery grid according to the present invention includes: a frame bone that includes a substantially rectangular shape; a lug portion that is connected to a first side portion of the frame bone and projects outwardly from the frame bone; a main bone that extends from a connection portion of the first side portion, to which the lug portion is connected, to a second side portion which is opposed to the first side portion; a sub-bone that extends from the first side portion to the second side portion; and a plurality of slanted bones that extend obliquely toward the second side portion, at least the plurality of slanted bones branching from the main bone toward both sides, wherein the plurality of slanted bones are arranged at intervals in a direction in which the main bone extends, and at least part of a plurality of spaces, which are defined by the main bone and the sub-bone that are partially forming sides of the spaces, include a substantially quadrilateral shape.

A method of manufacturing a storage battery grid according to the present invention includes: forming a frame bone that includes a substantially rectangular shape; forming a lug portion that is connected to a first side portion of the frame bone and projects outwardly from the frame bone; forming a main bone that extends from a connection portion of the first side portion, to which the lug portion is connected, to a second side portion which is opposed to the first side portion; forming a sub-bone that extends from the first side portion to the second side portion; forming a plurality of slanted bones that extend obliquely toward the second side portion, at least the plurality of slanted bones branching from the main bone toward both sides; arranging the plurality of slanted bones at intervals in a direction in which the main bone extends: and causing at least part of a plurality of spaces, which are defined by the main bone and the sub-bone that are partially forming sides of the spaces, to include a substantially quadrilateral shape.

With the above-described configuration, since the main bone extends from the connection portion of the first side portion, to which the lug portion is connected in the frame bone, to the second side portion, the distance between the lug portion and the second side portion of the frame bone can be reduced. The grid is provided with the sub-bone and at least the plurality of slanted bones extending slantwise from the main bone, thereby shortening a channel of a current, which is generated at a portion apart from the connection portion between the main bone and the second side portion of the frame bone, to the lug portion. In addition, the space defined by the main bone, the sub-bone, and the slanted bones includes a substantially quadrilateral shape, thereby reducing the number of bypass channels apart from the lug portion in comparison with a substantially triangular space. Consequently, in the entire grid, an electric resistance can be reduced and the potential distribution of the grid can be made uniform. In addition, the grid includes the frame bone formed into the rectangular shape, thus enhancing a mechanical strength.

It is preferable that part of the plurality of slanted bones branches from the first side portion of the frame bone. With this configuration, the channel of a current generated on both sides of the main bone includes the slanted bones and the first side portion in a linear manner, thus shortening a current channel so as to reduce the electric resistance of the grid.

It is preferable that part of the plurality of slanted bones branches from the connection portion, to which the lug portion is connected in the first side portion of the frame bone. With this configuration, a current flowing in the slanted bone is allowed to flow in the lug portion with a short distance not via any main bone, thus reducing the electric resistance of the grid.

It is preferable that the sub-bone includes a plurality of sub-bones arranged at intervals in a direction in which the first side portion extends, and the intervals of the sub-bones increase in a direction away from the main bone. With this configuration, the intervals between the sub-bones can be optimized depending on collected electric power. Consequently, the potential distribution of the grid can be made more uniform.

In that case, it is preferable that a plurality of spaces, which are defined by the second side portion, the sub-bone and the slanted bone that are partially forming sides of the spaces, include a substantially quadrilateral shape. With this configuration, the opening area of the space can be increased without increasing the electric resistance of the grid, and therefore, the workability for filling the grid with active material paste can be enhanced.

It is preferable that the main bone is arranged perpendicularly to the first side portion and the second side portion. With this configuration, the lug portion and the second side portion of the frame bone can be connected to each other with the shortest distance, and therefore, the electric resistance of the grid can be further reduced.

It is preferable that the grid is devoid of a lateral bone that is substantially parallel to the first side portion of the frame bone. With this configuration, the channel of the current, which is generated on both sides of the main bone, includes only the channel having a directional component orienting from the second side portion to the first side portion, and therefore, the channel reaching the main bone or the lug portion can be shortened, and the electric resistance of the grid can be reduced.

It is preferable that intervals of the slanted bones, which are part of the plurality of slanted bones and branching from the main bone, increase as the slanted bones extend away from the first side portion. With this configuration, the interval between the slanted bones can be optimized depending on collected electric power. Thus, the potential distribution of the grid can be made more uniform.

It is preferable that a slant angle of the slanted bones relative to the main bone increases as the slanted bones extend away from the first side portion, the slanted bones being part of the plurality of slanted bones and branching from the main bone. With this configuration, the slant angle of the slanted bone can be optimized depending on collected electric power. Thus, the potential distribution of the grid can be made more uniform.

It is preferable that a slant angle of the plurality of slanted bones is in a range from 5 degrees to 60 degrees. With this configuration, the channel reaching the main bone can be shortened. It is particularly preferable that the slant angle of the slanted bone is 45°.

It is preferable that a width of the main bone in a plan view decreases as it extends away from the lug portion. With this configuration, the shape of the main bone can be optimized depending on collected electric power. In other words, the width of a portion, which is apart from the lug portion and electric quantity flowing thereto is small, can be reduced. Thus, the material of the grid can be reduced and cost can be reduced.

It is preferable that a width of the first side portion in a plan view increases as it approaches to the lug portion. With this configuration, the mechanical strength of the grid can be enhanced, and also the potential distribution of the grid can be made more uniform.

A storage battery according to the present invention uses any one of the above-described storage battery grids.

With this configuration, the potential distribution of the grid can be made uniform, and a high rate discharge performance can be enhanced. The mechanical strength can be enhanced, and a cycle life performance can be enhanced.

It is preferable that the storage battery grid is made from a lead alloy. With this configuration, the present invention is applicable to the lead-acid storage battery grid.

It is preferable that the storage battery grid is formed by blanking. With this configuration, the thickness of the grid can be reduced (i.e., the mass of the grid can be reduced) in comparison with a grid formed by casting. Thus, the material of the grid can be reduced and cost can be reduced.

### Advantages of the Invention

According to the present invention configured as described above, the rectangular frame bone includes the main bone and the slanted bone, thus enhancing the mechanical strength of the grid. According to the present invention, the grid is provided with the plurality of slanted bones slantwise branched from the first side portion of the frame bone and the main bone, which extends from the connection portion of the first side portion to which the lug portion is connected, thus reducing the electric resistance of the grid, making the potential distribution of the grid uniform.

### BRIEF DESCRIPTION OF THE DRAWINGS

FIG. 1 depicts a perspective view showing a lead-acid storage battery grid of an embodiment.

FIG. 2 depicts a plan view showing the lead-acid storage battery grid of the embodiment.

FIG. 3 depicts a partly enlarged view showing the lead-acid storage battery grid of the embodiment.

FIG. 4 depicts a plan view showing a first modification of the lead-acid storage battery grid.

FIG. 5 depicts a plan view showing a second modification of the lead-acid storage battery grid.

FIG. 6 depicts a plan view showing a third modification of the lead-acid storage battery grid.

FIG. 7 depicts a plan view showing a fourth modification of the lead-acid storage battery grid.

FIG. 8 depicts a plan view showing a fifth modification of the lead-acid storage battery grid.

FIG. 9 depicts a plan view showing a sixth modification of the lead-acid storage battery grid.

FIG. 10 depicts a plan view showing a seventh modification of the lead-acid storage battery grid.

### MODE FOR CARRYING OUT THE INVENTION

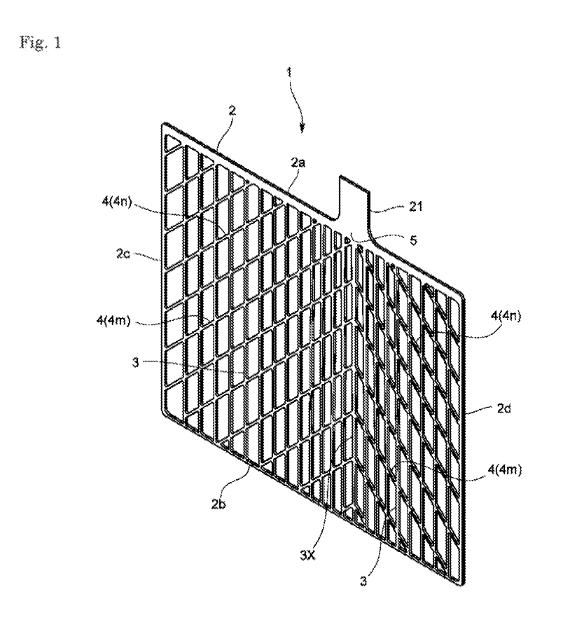

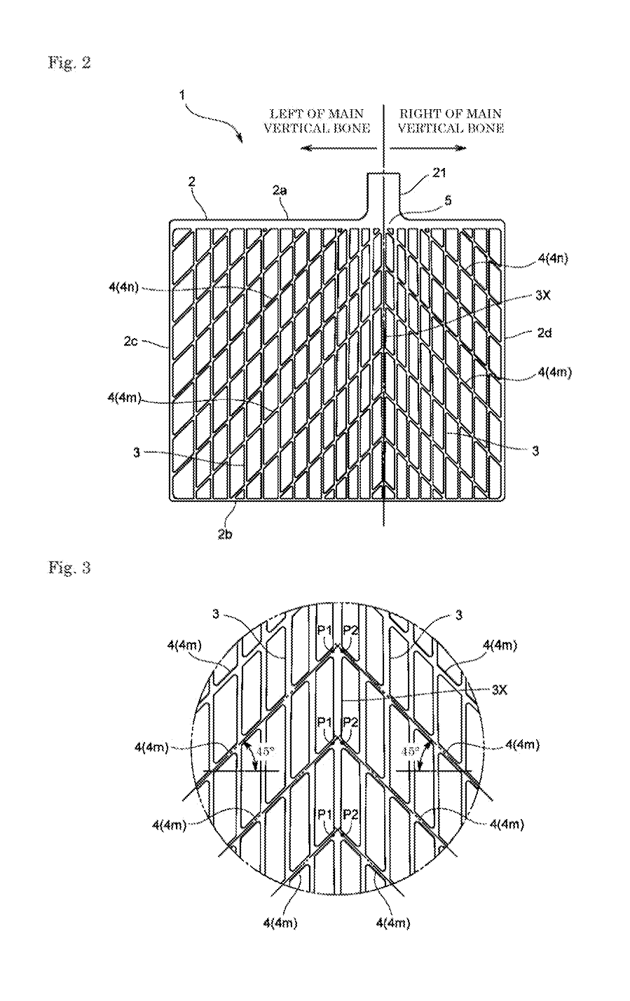

A description will be given below of an embodiment of a storage battery grid according to the present invention with reference to the attached drawings. In the present embodiment, explanation will be made by way of a grid for use in a lead-acid storage battery. Vertical and lateral directions on sheets of FIG. 1 and FIG. 2 are defined as vertical and lateral directions in the description.

A grid 1 in the present embodiment is used as one member of a positive plate or a negative plate in an electrode group serving as a power generating element for a lead-acid storage battery. In the case where the grid 1 is used for the positive plate, the grid 1 is filled with a positive active material (i.e., lead dioxide). In contrast, in the case where the grid 1 is used for the negative plate, the grid 1 is filled with a negative active material (i.e., spongy lead).

Specifically, the grid 1 is obtained by blanking a rolled sheet made of a lead alloy. As shown in FIGS. 1 and 2, the grid 1 includes a frame bone 2 formed into a substantially rectangular shape, a lug portion 21 projecting from an upper side 2a (i.e., a first side portion) of the frame bone 2 upward outside of a frame, a plurality of vertical bones 3 vertically extending in a linear manner inside of the frame bone 2, and a plurality of slanted bones 4 slantwise formed inside of the frame bone 2. The grid 1 in the present embodiment is devoid of a lateral bone substantially parallel to the upper side 2a of the frame bone 2.

Specifically, the grid 1 includes, out of the plurality of vertical bones 3, a main vertical bone 3X (i.e., a main bone) formed of one or more vertical bones 3 (three in the present embodiment) extending downward from right under a connection portion 5 to the lug portion 21 at the upper side 2a. The main vertical bone 3X is substantially perpendicular to the upper side 2a of the frame bone 2 and a lower side 2b (i.e., a second side portion) opposite to the upper side 2a, and is tapered with a gradually reduced width from the upper section to the lower section, as viewed on a plane. This can make the shape of a vertical bone most suitable for collected electric power. Since a width dimension is smaller at the lower section, a material of an electrode plate can be reduced.

The plurality of vertical bones 3 (i.e., sub-bones) arranged on right and left sides of the main vertical bone 3X are arranged at intervals in the lateral direction (i.e., the extending direction) of the upper side 2a, and they are formed such that the intervals become greater as they are more apart from the main vertical bone 3X toward the right and left sides. The plurality of vertical bones 3 arranged on the right and left sides of the main vertical bone 3X are configured such that the width of each of them becomes smaller as they are more apart from the main vertical bone 3X. This can make the interval between the vertical bones 3 most suitable for collected electric power. Other than that, the plurality of vertical bones 3 may be configured such that the width of each of them becomes smaller as they are more apart from the main vertical bone 3X.

The plurality of slanted bones 4 include at least slanted bones 4 extending slantwise downward from the main vertical bone 3X in a linear manner. In other words, the plurality of slanted bones 4 include: a plurality of slanted bones 4 (4m) branched from the main vertical bone 3X and extending slantwise downward: and a plurality of slanted bones 4 (4n) branched from the upper side 2a of the frame bone 2 and extending slantwise downward. Some (two in the present embodiment) of the slanted bones 4 are branched from the connection portion 5 to the lug portion 21 at the upper side 2a. Thus, the upper ends of the slanted bones 4 are connected to the main vertical bone 3X or the upper side 2a of the frame bone 2; the lower ends of the slanted bones 4 are connected to the sides 2c or 2d or lower side 2b of the frame bone 2. In other words, the lower ends of the slanted bones 4 extend to reach the frame bone 2.

The plurality of slanted bones 4 are formed into a substantially inverted V shape from the main vertical bone 3X, as viewed on a plane, and therefore, they are branched from at least the main vertical bone 3X rightward and leftward of the main vertical bone 3X, and further, extend slantwise from the upper side 2a to the lower side 2b. Specifically, the plurality of slanted bones 4 are formed into a substantially linear manner in which they are inclined upward near the main vertical bone 3X, as viewed on a plane. Here, a space defined by the main vertical bone 3X and the like is formed into a substantially quadrilateral shape. In this manner, since the slanted bones 4 are substantially linear, the channel of a current generated on the right and left sides of the main vertical bone 3X becomes linear, thereby shortening the channel of a current to the main vertical bone 3X or the upper side 2a.

Specifically, the plurality of slanted bones 4 formed on the left side of the main vertical bone 3X are arranged with the intervals in the vertical direction (i.e., the extending direction) of the main vertical bone 3X at an slant angle of 45° with respect to the main vertical bone 3X, as shown in FIG. 3. The plurality of slanted bones 4 formed on the right side of the main vertical bone 3X are arranged with the intervals in the vertical direction of the main vertical bone 3X at an slant angle of 45 with respect to the main vertical bone 3X. A connection point P1 at the upper end of each of the slanted bones 4 (4m) formed on the left side and a connection point P2 at the upper end of each of the slanted bones 4 (4m) formed on the right side mate with each other in a height direction at the main vertical bone 3X. With the above-described configuration, the slanted bones 4 formed on the left side of the main vertical bone 3X and the slanted bones 4 formed on the right side of the main vertical bone 3X are laterally symmetric with each other with respect to the main vertical bone 3X.

The plurality of slanted bones 4 formed on the left side of the main vertical bone 3X are formed substantially in parallel to each other, and the plurality of slanted bones 4 formed on the right side of the main vertical bone 3X are formed substantially in parallel to each other. In this manner, the plurality of slanted bones 4 are formed substantially in parallel to each other, and therefore, a potential distribution can be made more uniform. The interval between the adjacent slanted bones 4 may be identical to each other, may be different from each other, or may be enlarged downward. In other words, the intervals between the slanted bones 4 may be varied so as to make the potential distribution uniform.

As described above, the grid 1 in the present embodiment includes: the frame bone 2 formed into a rectangular shape; the lug portion 21 that is connected to the upper side 2a of the frame bone 2 and projects outward from a frame; the main vertical bone 3X that vertically extends from the connection portion between the upper side 2a and the lug portion 21 to the lower side 2b opposite to the upper side 2a, the width of the main vertical bone 3X becoming smaller apart from the lug portion 21, as viewed on a plane; the plurality of vertical bones 3 extending from the upper side 2a to the lower side 2b, arranged in the extending direction of the upper side 2a of the frame bone 2 with the intervals that become greater apart from the main vertical bone 3X; and the plurality of slanted bones 4 that are branched from at least the main vertical bone 3X toward both sides and extend slantwise toward the lower side 2b at the slant angle from 5° to 60°. The plurality of slanted bones 4 are arranged with the intervals in the extending direction of the main vertical bone 3X. Some of the slanted bones 4 are branched from the upper side 2a of the frame bone 2, and further, some of the slanted bones 4 are branched from the connection portion to the lug portion 21 at the upper side 2a of the frame bone 2. Each of the plurality of spaces defined by the main vertical bone 3X, the vertical bone 3, and the like is at least partly formed into a substantially quadrilateral shape. Each of the plurality of spaces defined by the lower side 2b of the frame bone 2, the vertical bone 3, the slanted bone 4, and the like is partly formed into a substantially quadrilateral shape. Additionally, out of the plurality of slanted bones 4, the intervals between the plurality of slanted bones 4 branched from the main vertical bone 3X become greater apart from the upper side 2a of the frame bone 2.

Next, results from potential distribution analyses carried out with respect to the grid 1 such configured as described above and a conventional expanded grid will be shown below. The conventional expanded grid had a grid dimension [a width (mm)×a height (mm)] of 137.0×115.0, a grid thickness (mm) of 1.00, and a grid mass (g) of 42.0. In contrast, the lead-acid storage battery grid according to the present invention had a grid dimension [a width (mm)×a height (mm)] of 137.0×115.0, a grid thickness (mm) of 0.80, and a grid mass (g) of 42.0. A current of 1 A was made to flow at the upper end of the lug portion in each of the conventional expanded grid and the lead-acid storage battery grid according to the present invention, followed by a potential distribution analysis.

The rate of a potential drop (i.e., a voltage drop) with reference (0V) to a lower frame of the conventional expanded grid is assumed as 100%. In the case where the slant angle of the slanted bone of the lead-acid storage battery grid according to the present invention is varied from 0° to 80°, the rate of a potential drop with reference (0V) to the lower side of the lead-acid storage battery grid according to the present invention and the uniformity of a potential distribution are shown in Table 1.

TABLE 1

| | SLANT | | UNIFORMITY | |
|---|---|---|---|---|
| | ANGLE | RATE OF | OF POTENTIAL | |
| | OF | POTENTIAL | DISTRIBUTION | |
| | SLANTED | DROP OF | OVER ENTIRE | |
| GRID | BONE | GRID (%) | GRID | REMARKS |
| CONVENTIONAL | — | 100 | x | PRIOR ART |
| EXPANDED | | | | |
| GRID | | | | |
| LEAD-ACID | 0 | 50 | ∘ | COMPARATIVE |
| STORAGE | | | | EXAMPLE |
| BATTERY GRID | 5 | 48 | ⊙ | EXAMPLE |
| ACCORDING TO | 15 | 48 | ⊙ | EXAMPLE |
| PRESENT | 25 | 48 | ⊙ | EXAMPLE |
| INVENTION | 30 | 48 | ⊙ | EXAMPLE |
| | 35 | 48 | ⊙ | EXAMPLE |
| | 45 | 48 | ⊙ | EXAMPLE |
| | 60 | 49 | ⊙ | EXAMPLE |
| | 80 | 50 | ∘ | COMPARATIVE |
| | | | | EXAMPLE |

* UNIFORMITY OF POTENTIAL DISTRIBUTION . . . ⊙: EXCELLENT, ∘: GOOD, x: BAD

The rate of the potential drop of the lead-acid storage battery grid according to the present invention was decreased down to 48% to 50% of that of the conventional expanded grid. The uniformity of the potential distribution of the lead-acid storage battery grid according to the present invention was ⊙ or ◯ (excellent or good), that is, it was more excellent than that of the conventional expanded grid since the uniformity of the potential distribution of the conventional expanded grid was x (bad). In view of this, it was found that the potential distribution of the entire lead-acid storage battery grid according to the present invention was made to be uniform in comparison with that of the conventional expanded grid. The uniformity of the potential distribution of the entire grid when the slant angle of the slanted bone of the lead-acid storage battery grid according to the present invention ranged from 0° to 80° was ◯ (good), and further, the uniformity of the potential distribution when the slant angle of the slanted bone of the lead-acid storage battery grid according to the present invention ranged from 5° to 60° was ⊙ (excellent). It was found from the results that the potential distribution was made to be more uniform within the range from 5° to 60° of the slant angle of the slanted bone of the lead-acid storage battery grid according to the present invention.

In this manner, the use of the lead-acid storage battery grid according to the present invention for a lead-acid storage battery can enhance a high rate discharge performance (a cold cranking current and a low temperature high rate discharge performance) more than the use of the conventional expanded grid when it has almost the same lead mass as that of the conventional expanded grid. In the meantime, when an electrode plate for a lead-acid storage battery according to the present invention is used for a lead-acid storage battery, substantially the same high rate discharge performance (a cold cranking current and a low temperature high rate discharge performance) as that of the conventional expanded grid can be achieved by an electrode plate having a smaller lead mass.

The results of elongation analyses carried out with respect to the above-described conventional expanded grid and the above-described lead-acid storage battery grid according to the present invention are shown in Table 2.

TABLE 2

| | | RATE OF GRID | | |
|---|---|---|---|---|
| | SLANT | ELONGATION (%) | | |
| | ANGLE | WIDTH | HEIGHT | |
| | OF | DIRECTION | DIRECTION | |
| | SLANTED | (LATERAL | (VERTICAL | |
| GRID | BONE | DIRECTION) | DIRECTION) | REMARKS |
| CONVENTIONAL | — | 100 | 100 | PRIOR ART |
| EXPANDED | | | | |
| GRID | | | | |
| LEAD-ACID | 0 | 50 | 57 | COMPARATIVE |
| STORAGE | | | | EXAMPLE |
| BATTERY GRID | 5 | 50 | 57 | EXAMPLE |
| ACCORDING TO | 15 | 50 | 57 | EXAMPLE |
| PRESENT | 60 | 57 | | EXAMPLE |
| INVENTION | 30 | 70 | 43 | EXAMPLE |
| | 35 | 80 | 43 | EXAMPLE |
| | 45 | 80 | 43 | EXAMPLE |
| | 60 | 50 | 43 | EXAMPLE |
| | 80 | 50 | 43 | COMPARATIVE |
| | | | | EXAMPLE |

Assuming that each of the rate of a grid elongation in the width direction (i.e., the lateral direction) of the conventional expanded grid and the rate of a grid elongation in the height direction (i.e., the vertical direction) of the conventional expanded grid was set to 100%, the rate of a grid elongation in the width direction in the lead-acid storage battery grid according to the present invention ranged from 50% to 80% of that of the conventional expanded grid whereas the rate of a grid elongation in the height direction ranged from 43% to 57%: namely, they were decreased. In view of these, it was found that the grid elongation in each of the width direction and the height direction was decreased in the lead-acid storage battery grid according to the present invention. Consequently, the cycle life performance of the lead-acid storage battery using the grid according to the present invention can be enhanced, for example, the number of cycles in a cycle life test at an ambient temperature of 75° pursuant to the light load lifetime test determined by JIS 5301 is increased.

With the grid 1 according to the present embodiment such configured as described above, the main vertical bone 3X is disposed under the lug portion 21, and therefore, the distance between the lug portion 21 and the lower side 2b of the frame bone 2 can be shortened. The plurality of slanted bones 4 extend slantwise downward from at least the main vertical bone 3X, and therefore, the channel for a current generated at the sides of the main vertical bone 3X toward the main vertical bone 3X or the lug portion 21 can be shortened. Additionally, the plurality of slanted bones 4 are formed into the substantially inverted V shape on the main vertical bone 3X, as viewed on a plane, and therefore, the channels for currents generated on the right and left sides of the main vertical bone 3X toward the main vertical bone 3X or the lug portion 21 can be shortened. Furthermore, the space defined by the main vertical bone 3X and the slanted bones 4 is formed into the substantially quadrilateral shape, thereby reducing bypass channels remote from the lug portion 2 in comparison with a triangular shape. Consequently, in the entire grid 1, an electric resistance can be decreased and the potential distribution of the electrode plate can be made uniform. In addition, the frame bone 2 is formed into the substantially rectangular shape, thus enhancing a mechanical strength.

The grid 1 of the present embodiment includes the plurality of vertical bones 3 and the plurality of slanted bones 4 but is devoid of the lateral bone substantially parallel to the upper side 2a of the frame bone 2. Therefore, the channel of the current generated on the right and left sides of the main vertical bone 3X includes only the upward channel formed of the vertical bones 3 and the slantwise upward channel formed of the slanted bones 4. The channel reaching the lug portion 21 via the main vertical bone 3X and the upper side 2a can be shortened, thus reducing the electric resistance.

Since the grid 1 is formed by blanking, the thickness of the grid can be further reduced (that is, the mass of the grid can be further reduced) in comparison with the case where the grid is formed by casting. As a consequence, the material of the grid is reduced, thus reducing a cost. A difference in thickness of the grid is caused by a difference in corrosion mode due to a difference in metallic tissue. In general, a cast grid has a large crystalline grain. Corrosion proceeds in such a manner as to enter a crystalline grain field, and therefore, the cast grid has characteristics of a small corrosion ratio at which the grid is broken. In contrast, the punched grid manufactured by blanking a rolled sheet is rolled after the fabrication of a slab, so that a large crystalline grain contained in the slab is elongated in a roll direction. In this manner, there is no crystalline grain field that may break the grid, and thus, corrosion sequentially proceeds from the grid surface. With these characteristics, the punched grid manufactured with the rolling sheet can be reduced in grid thickness in comparison with the cast grid.

The grid 1 is manufactured by blanking or casting in the following manner. A rectangular frame bone is formed. A lug portion is formed in such a manner as to be connected to a first side portion of the frame bone and project outward of a frame. A main bone is formed in such a manner as to extend from a connection portion to the lug portion at the first side portion to a second side portion opposite to the first side portion. A sub-bone is formed in such a manner as to extend from the first side portion to the second side portion. A plurality of slanted bones are formed in such a manner as to be branched from at least the main bone toward both sides and slantwise extend toward the second side portion. The plurality of slanted bones are arranged at intervals in the extending direction of the main bone. Each of a plurality of spaces defined by the main bone, the sub-bones, and the like is at least partly formed into a substantially quadrilateral shape.

Incidentally, the present invention is not limited to the above-described embodiment.

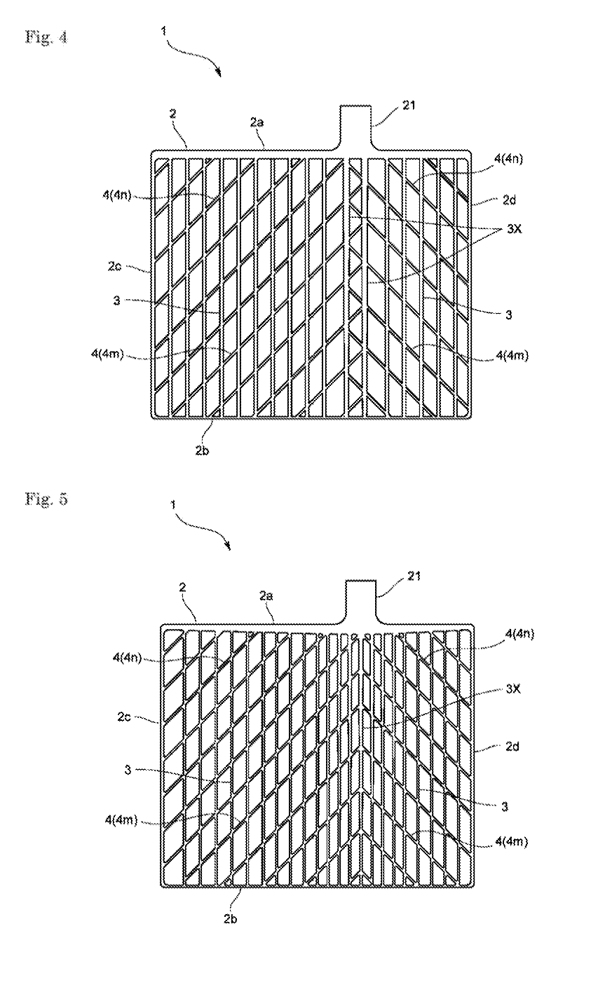

For example, in the above-described embodiment, the main vertical bone 3X is formed of one vertical bone 3, and the plurality of slanted bones 4 extend from the main vertical bone 3X. However, a main vertical bone 3X may be formed of a plurality of vertical bones 3 (two in FIG. 4), and a plurality of slanted bones 4 may extend from the plurality of main vertical bones 3X, as shown in FIG. 4.

Furthermore, as shown in FIG. 5, an upper side 2a of a frame bone 2 may be increased in height toward a lug portion 21, as viewed on a plane. Specifically, the lower surface of the upper side 2a of the frame bone 2 is formed into a substantially V shape inclined downward toward the lug portion 21 from both ends thereof. Consequently, the mechanical strength of a grid 1 can be enhanced, and further, a potential distribution of an electrode plate can be made more uniform.

Not only a main vertical bone 3X but also other vertical bones 3 may be decreased in width from the upper section to the lower section. FIG. 5 shows a case where three vertical bones 3 on right and left sides of the main vertical bone 3X are decreased in width from the upper section to the lower section.

The slant angle (e.g., 45°) of each of the plurality of slanted bones 4 on the left side of the main vertical bone 3X and the slant angle (e.g., 45°) of each of the plurality of slanted bones 4 on the right side of the main vertical bone 3X are the same in the above-described embodiment. However, the slant angles of slanted bones 4 on right and left sides may be different from each other. Specifically the slant angle of each of a plurality of slanted bones 4 on the left side of the main vertical bone 3X may be 45° whereas the slant angle of each of a plurality of slanted bones 4 on the right side of the main vertical bone 3X may be 60°.

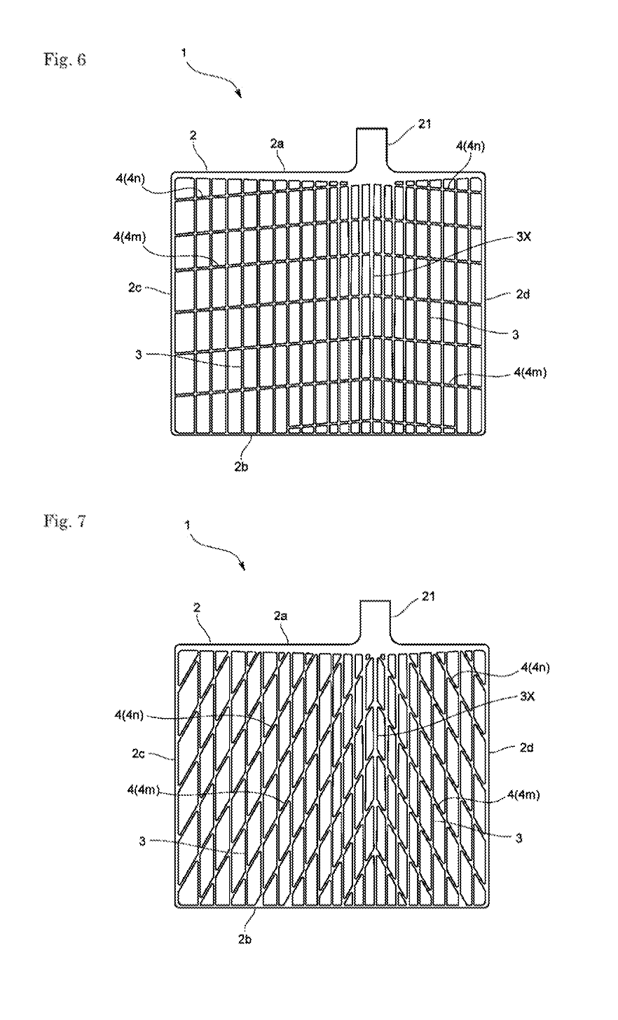

Although the slant angle of each of the slanted bones 4 is 45° in the above-described embodiment, it may be other values. As shown in FIG. 6, the slant angle of the slanted bone 4 may be 5° in a lateral direction in FIG. 6 (i.e., 85° with respect to a main vertical bone 3X). As shown in FIG. 7, the slant angle may be 60° (i.e., 30° with respect to a main vertical bone 3X).

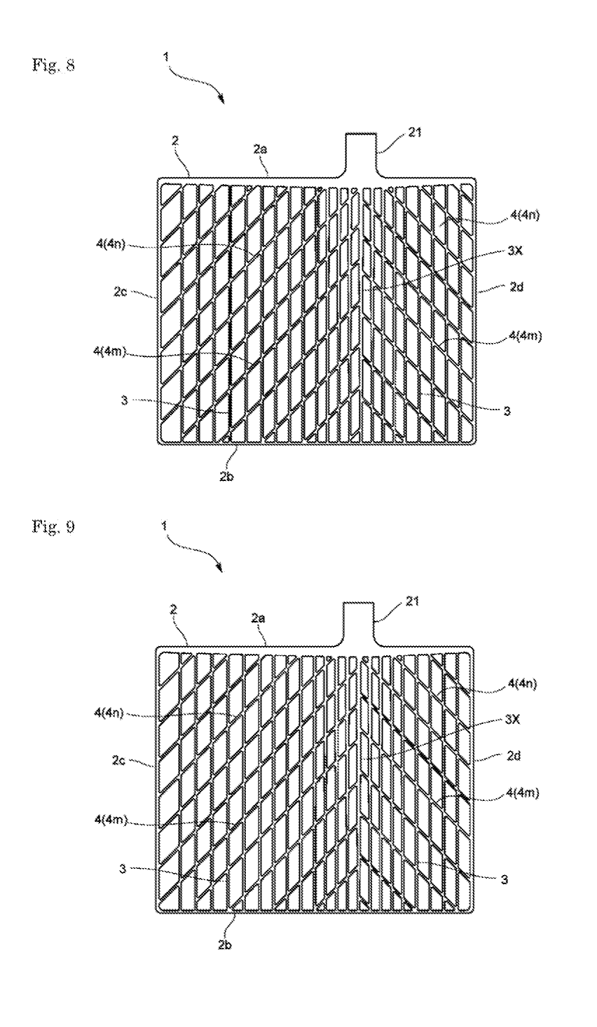

Although the connection portions of the slanted bones 4 on the right and left sides are the same as each other in the height direction in the above-described embodiment, they may be shifted from each other in a height direction, as shown in FIGS. 8 and 9.

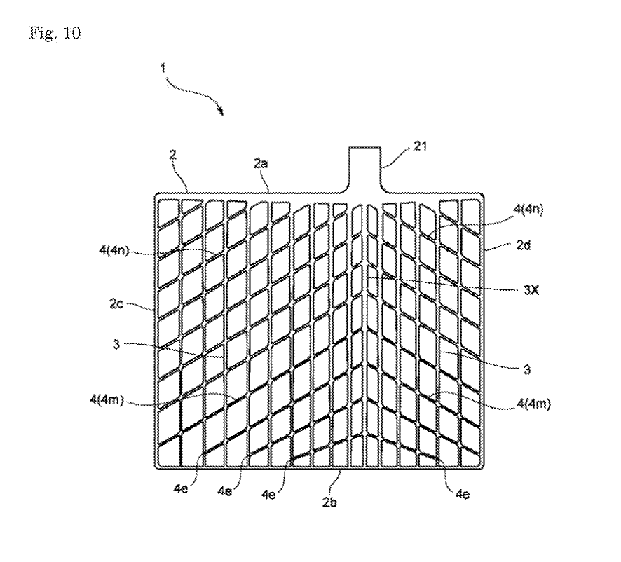

Although all of the slanted bones 4 are connected to the lower side 2b or side 2c or 2d of the frame bone 2 in the above-described embodiment, some of the slanted bones 4 may not be connected to the lower side 2b or side 2c or 2d of the frame bone 2. For example, as shown in FIG. 10, out of a plurality of slanted bones 4, the slanted bones 4 that cross a side 2c or 2d of the frame bone 2 when linearly extending are connected to the side 2c or 2d, like the above-described embodiment: in contrast, out of the plurality of slanted bones 4, the slanted bones 4 that cross a lower side 2b of the frame bone 2 when linearly extending are connected to the vertical bone 3 immediately before or more beforehand of the lower side 2b, and further, an end 4e of the slanted bone 4 is formed at the vertical bone 3 immediately before or more beforehand of the lower side 2b. In this case, each of a plurality of spaces defined by the lower side 2b and the like is formed into a substantially quadrilateral shape. The slant angles of a plurality of slanted bones 4m branched from the main vertical bone 3X with respect to the main vertical bone 3X become greater apart from the upper side 2a of the frame bone 2. In the grid shown in FIG. 10, the slant angle of the slanted bone 4m nearest the upper side 2a is 30° (i.e., 60° with respect to the main vertical bone 3X), and further, the slant angle of the remotest slanted bone 4m is 20° (i.e., 70° with respect to the main vertical bone 3X). In this manner, the optimum slant angle of the slanted bone 4m can be set depending on collected electric power. Thus, the potential distribution of the grid 1 can be made more uniform, and the workability for filling the grid with the active material can be enhanced.

Although the grid includes the plurality of slanted bones 4 (4m) slantwise extending downward from the main vertical bone 3X and the plurality of slanted bones 4 (4n) slantwise extending downward from the upper side 2a of the frame bone 2 in the above-described embodiment, the grid may be devoid of slanted bones 4 (4n) slantwise extending downward from the upper side 2a.

Although the grid used for a lead-acid storage battery is exemplified in the above-described embodiment, the present invention is not limited to this. For example, the grid according to the present invention is applicable to a grid filled with an active material for a nickel-metal hydride battery and the like.

Although the grid 1 is formed by blanking in the above-described embodiment, it may be formed by casting.

Although the grid in the above-described embodiment includes the upper side out of the four sides of the frame bone as the first side portion and the lower side as the second side portion, one of the right and left sides out of the four sides of the frame bone may be used as a first side portion whereas the other may be used as a second side portion.

The present invention is not limited to the above-described embodiment, and it may be variously modified without departing from the scope.

### DESCRIPTION OF REFERENCE SIGNS

1 grid
2 frame bone
2a upper side
2b lower side
21 lug portion
3 vertical bone
3X main vertical bone
4 slanted bone
5 connection portion

1. A storage battery grid comprising:
a frame bone that includes a substantially rectangular shape;
a lug portion that is connected to a first side portion of the frame bone and projects outwardly from the frame bone;
a main bone that extends from a connection portion of the first side portion, to which the lug portion is connected, to a second side portion which is opposed to the first side portion;
a sub-bone that extends from the first side portion to the second side portion; and
a plurality of slanted bones that extend obliquely toward the second side portion, at least part of the plurality of slanted bones branching from the main bone toward both sides,
wherein the plurality of slanted bones are arranged at intervals in a direction in which the main bone extends, and
at least part of a plurality of spaces, which are defined by the main bone and the sub-bone that are partially forming sides of the spaces, include a substantially quadrilateral shape.

2. The storage battery grid according to claim 1, wherein part of the plurality of slanted bones branches from the first side portion of the frame bone.

3. The storage battery grid according to claim 1, wherein part of the plurality of slanted bones branches from the connection portion, to which the lug portion is connected in the first side portion of the frame bone.

4. The storage battery grid according to claim 1, wherein the sub-bone comprises a plurality of sub-bones arranged at intervals in a direction in which the first side portion extends, and
the intervals of the sub-bones increase in a direction away from the main bone.

5. The storage battery grid according to claim 4, wherein a plurality of spaces, which are defined by the second side portion, the sub-bone and the slanted bone that are partially forming sides of the spaces, include a substantially quadrilateral shape.

6. The storage battery grid according to claim 1, wherein the main bone is arranged perpendicularly to the first side portion and the second side portion.

7. The storage battery grid according to claim 1, wherein the grid is devoid of a lateral bone that is substantially parallel to the first side portion of the frame bone.

8. The storage battery grid according to claim 1, wherein intervals of the slanted bones, which are part of the plurality of slanted bones and branching from the main bone, increase as the slanted bones extend away from the first side portion.

9. The storage battery grid according to claim 1, wherein a slant angle of the slanted bones relative to the main bone increases as the slanted bones extend away from the first side portion, the slanted bones being part of the plurality of slanted bones and branching from the main bone.

10. The storage battery grid according to claim 1, wherein a slant angle of the plurality of slanted bones is in a range from 5 degrees to 60 degrees.

11. The storage battery grid according to claim 1, wherein a width of the main bone in a plan view decreases as it extends away from the lug portion.

12. The storage battery grid according to claim 1, wherein a width of the first side portion in a plan view increases as it approaches to the lug portion.

13. A storage battery comprising the storage battery grid according to claim 1.

14. The storage battery according to claim 13, wherein the storage battery grid is made from a lead alloy.

15. The storage battery according to claim 13, wherein the storage battery grid is formed by blanking.

16. A method of manufacturing a storage battery grid comprising:
forming a frame bone that includes a substantially rectangular shape;
forming a lug portion that is connected to a first side portion of the frame bone and projects outwardly from the frame bone;
forming a main bone that extends from a connection portion of the first side portion, to which the lug portion is connected, to a second side portion which is opposed to the first side portion;
forming a sub-bone that extends from the first side portion to the second side portion;
forming a plurality of slanted bones that extend obliquely toward the second side portion, at least part of the plurality of slanted bones branching from the main bone toward both sides;
arranging the plurality of slanted bones at intervals in a direction in which the main bone extends; and
causing at least part of a plurality of spaces, which are defined by the main bone and the sub-bone that are partially forming sides of the spaces, to include a substantially quadrilateral shape.

17. A storage battery grid comprising:
a frame bone that includes a substantially rectangular shape;
a lug portion that is connected to a connection portion of a first side portion of the frame bone, and extends outwardly from the first side portion;
a main bone that extends perpendicularly from the connection portion to a second side portion of the frame bone which is opposed to the first side portion, a width of the main bone in a plan view decreasing in a direction away from the lug portion;
a plurality of sub-bones which extend parallel to the main bone from the first side portion to the second side portion, the plurality of sub-bones comprising first sub-bones formed between the main bone and a third side portion of the frame bone, and second sub-bones formed between the main bone and a fourth side portion of the frame bone which is opposite the third side portion, the plurality of sub-bones being formed at intervals in a direction along the first side portion, and the intervals increasing in a direction away from the main bone; and
a plurality of slanted bones which extend obliquely toward the second side portion, a slant angle of the plurality of slanted bones being in a range from 5 degrees to 60 degrees, and the plurality of slanted bones comprising:
first slanted bones branching from the main bone and intersecting the sub-bone to form a plurality of quadrilateral spaces including a side defined by the main bone, the first slanted bones intersecting the plurality of sub-bones to form a plurality of quadrilateral spaces including a side defined by the second side portion.

18. The storage battery grid according to claim 17, wherein the plurality of slanted bones further comprises:
second slanted bones which are branched from the first side portion; and
third slanted bones which are branched from the connection portion.

19. The storage battery grid according to claim 17, wherein the first slanted bones are branched at intervals from the main bone, the intervals increasing as the first slanted bones extend toward the second side portion.

20. The storage battery grid according to claim 17, wherein a slant angle of the first slanted bones relative to the main bone increases in a direction toward the second side portion.
